(19) United States
(12) Patent Application Publication
(10) Pub. No.: US 2004/0211426 A1
(43) Pub. Date: Oct. 28, 2004

(54) Mouth nose and eye mask

(76) Inventor: Fu-Sheng Lai, Keelung City (TW)

Correspondence Address: Fu-Sheng LAI, P.O. Box No. 6-57, Junghe, Taipei, 235, TW

(21) Appl. No.: 10/829,974

(22) Filed: Apr. 23, 2004

(30) Foreign Application Priority Data
Apr. 28, 2003 (TW) 092206755

(51) Int. Cl. A62B 18/08

(52) U.S. Cl. 128/206.21; 128/206.23

(57) ABSTRACT

A mouth, nose and eye mask including the mouth and nose mask made from leached material, and tightening straps attached to each of two sides; and characterized in that an extended eye mask is configured on an upper edge of the mouth and nose mask; an opening is defined in a central portion of the eye mask, and tightening straps are attached to outer sides of the eye mask; a peripheral edge of a flexible and transparent thin sheet is adhered to an outer surface or inner surface of an edging of the opening. Thus, when the mouth, nose and eye mask together cover the mouth and nose of a user, the outer peripheral edge of the eye mask tightly fits round the eyes portion and skin of the face of a user, effectuating airtight effectiveness, and further preventing viruses and bacteria from entering the eyes.

### BACKGROUND OF THE INVENTION

(a) Field of the Invention

The present invention relates to a mouth, nose and eye mask, and more particularly to the eye mask that effectively realizes an airtight fitting around the eyes of a person.

(b) Description of the Prior Art

According to structure of a conventional mouth, nose, and eye mask, for instance, as disclosed in Taiwan publication No.290870 with an invention named “Easy and Convenient Mouth, Nose, and Eye Mask”, which is structured to comprise a respirator, a nose mask and two thin lens made from transparent synthetic material, wherein usage of such a configuration includes following shortcomings:

Because circumferential edges of two lenses utilize soft woven straps to sew and thus connect to a respirator thereof, therefore processing costs are high; and because surface shape of the face of a person includes areas which are concave and convex in nature, moreover, build of the face varies from person to person, thus, utilizing the soft woven straps attached to a lens frame results in inability of the eye mask to effectively realize an airtight fit with surrounding area of the eyes or face of the person (that is, ineffective airtight effectiveness results). Hence, the eye mask is unable to effectively block viruses and bacteria of minute molecular structure.

### SUMMARY OF THE INVENTION

A primary objective of the present invention is to provide an improved configuration for a mouth, nose and eye mask utilizing a transparent and flexible plastic thin sheet as a lens, and a peripheral edge of the thin sheet utilizes adhesive to attach to an outer peripheral edge of an outwardly extending eye mask, moreover, moldable metallic strips are adhered to a surface of the outer peripheral edge of the eye mask, thereby when the mouth, nose and eye mask together cover the mouth and nose of a user, the outer peripheral edge of the eye mask tightly fits round the eyes portion and skin of the face of the user, effectuating airtight effectiveness, and further preventing viruses and bacteria from entering the eyes.

Another objective of the present invention is to provide the mouth, nose and eye mask that adapts an adhesive binding method to join the lens to the eye mask, and thus expediting processing production of such.

Referring to FIGS. 1 and 2, which show the mouth, nose and eye mask 10 of the present invention having a configuration that embodies:

The mouth and nose mask 10 made from leached material, and tightening straps 12 attached to each of two sides; and characterized in that an extended eye mask 20 is configured on an upper edge of the mouth and nose mask 10. An opening 22 is defined in a central portion of the eye mask 20, and tightening straps 24 are attached to outer sides of the eye mask 20. A peripheral edge of the flexible and transparent thin sheet 30 is adhered to an outer surface or inner surface of an edging of the opening 22.

According to aforementioned primary characteristics, thickness of the thin sheet 30 is controlled so as to be kept between 0.05-0.3 m/m thick.

According to aforementioned primary characteristics the moldable metallic strips 40 are adhered at an appropriate position to a surface of an extended side 23 of the outer peripheral edge of the eye mask 20. The metallic strips 40 are deformable, and the extended side 23 of the outer peripheral of the eye mask 20 tightly fits on surface of the skin of the face of the user.

According to aforementioned primary characteristics a surface of the thin sheet 30 is plated with or a coating of an extremely thin film of a photo-catalyst is applied there onto, wherein composition of the film is primarily a chemical compound of titanic oxide (TiO₂).

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded elevational view according to the present invention.

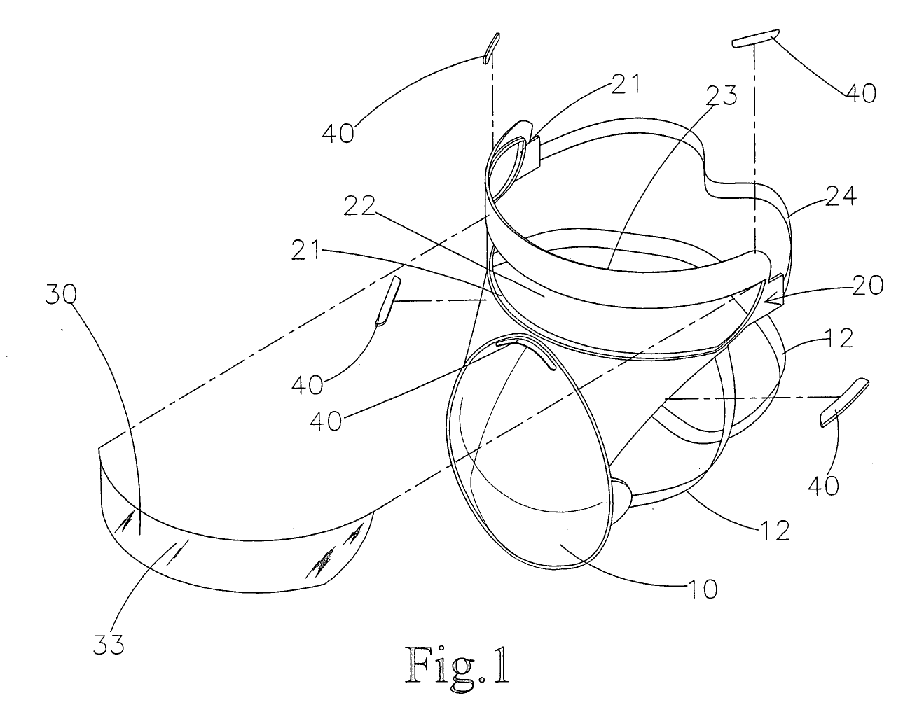

FIG. 2 shows a front view according to the present invention.

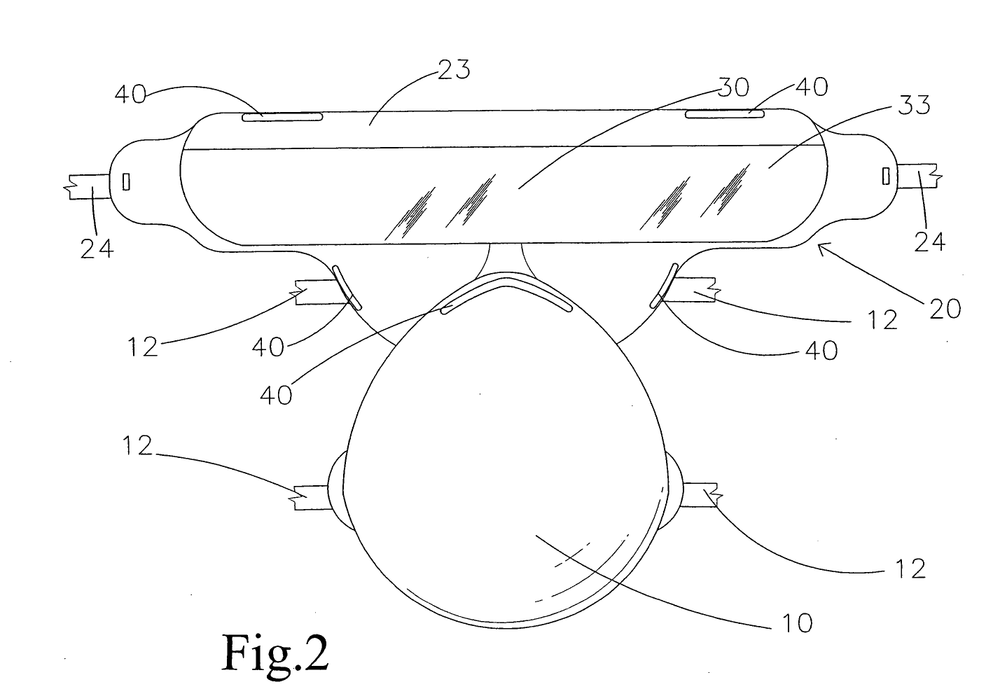

FIG. 3 shows a side schematic view of an embodiment according to the present invention.

FIG. 4 shows an enlarged side view of an eye mask according to the present invention.

FIG. 5 shows a side schematic view of another embodiment according to the present invention.

### DETAILED DESCRIPTION OF THE PREFERRED EMBODIMENTS

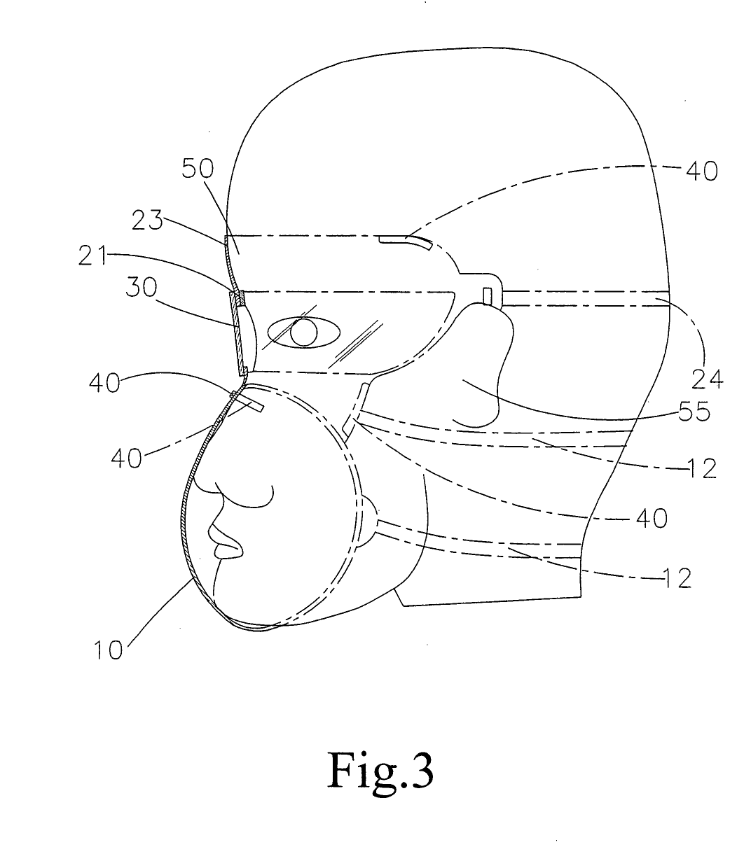

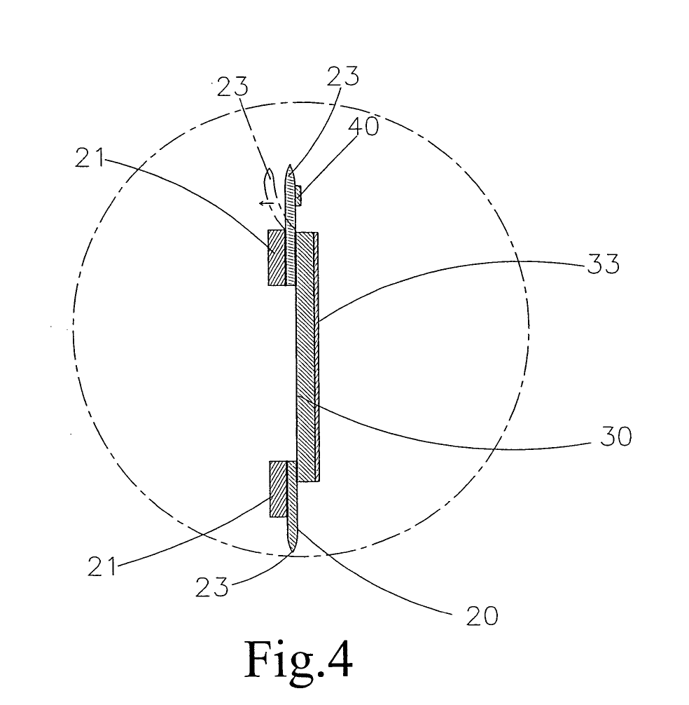

Referring to FIGS. 3 and 4, which show an eye mask 20 of the present invention, and which adapts a thin sheet 30 as a main body. The thin sheet 30 is preferably fabricated from transparent and flexible plastic thin sheet material of 0.05˜0.03 m/m thickness. Tightening straps 12 and 24 are fastened to outer edges of a mouth and nose mask 10 and the eye mask 20 respectively, and tightened at back of the head of a user. The eye mask 20 corresponds to surrounding area of the eyes and skin 50 above bridge of the nose of the user thereof. Accordingly, because build of the face varies from person to person, a finger of a user can be employed to suppress metallic strips 40 (for instance, aluminum strips) of the eye mask 20, thereby malleably deforming the metallic strips 40 and allowing a soft padding 21 of the circumferential edge of the eye mask 20 to fit tightly to surface of the skin of the user.

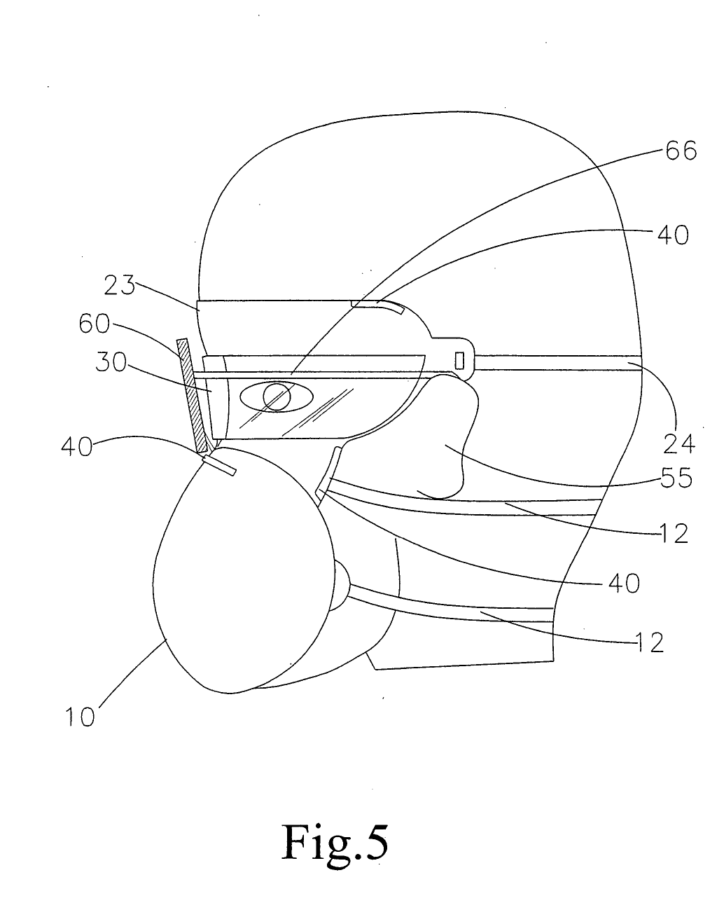

Hence, the flexible transparent thin sheet 30 forms an arc-shaped tight-fitting member that surrounds the eyes portion of the user, and thereby the eye mask 20 realizes a worry-free fitting that does not protrude outwards from the eyes portion, thus facilitating side arms 66 of traditional glasses 60 to be conveniently hooked around the ears 55 of the user (see FIG. 5).

Referring to FIG. 4, depending on requirements, surface of the thin sheet 30 can be plated with or a coating of an extremely thin film 33 of a photo catalyst can be applied there onto, wherein composition of the film 33 is primarily a chemical compound of titanic oxide (TiO₂). Because the coating adheres to the thin sheet 30 in a form of a film 33, therefore the film 33 does not influence transparent effectiveness of the thin sheet 30. Whereby, upon a light source striking the surface of the thin sheet 30, the photo-catalyst produces a chemical reaction and an electrical reaction, which thereby kills any viruses and bacteria thereat. Furthermore, binding of the thin sheet 30 and the metallic strips 40 to the surface of the eye mask 20 equally adopt an adhesive binding method to realize such, thereby expediting implementation of processing work of such.

Thickness of the extended side 23 having attached metallic strips 40 is adapted to be relatively thinner, thereby enhancing effectiveness of the tight-fitting of the extended side 23 and the eye mask 20 on the skin 50.

In conclusion, characteristics of the present invention include the eye mask 20 having greater airtight effectiveness, and the surface of the thin sheet 30 having greater sterilizing and bactericidal effectiveness, which therewith achieve advancement and practicability of a new model, and which assuredly conforms with essential items as required for a patent application. Accordingly, an application is proposed herein.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A mouth, nose and eye mask comprising:
the mouth and nose mask made from leached material, and tightening straps attached to each of two sides; and characterized in that an extended eye mask is configured on an upper edge of the mouth and nose mask; an opening is defined in a central portion of the eye mask, and tightening straps are attached to outer sides of the eye mask; a peripheral edge of a flexible and transparent thin sheet is adhered to an outer surface or inner surface of an edging of the opening.

2. The mouth, nose and eye mask according to claim 1, wherein thickness of the thin sheet is controlled so as to be kept between 0.05-0.3 m/m thick.

3. The mouth, nose and eye mask according to claim 1, wherein moldable metallic strips are adhered at an appropriate position to a surface of an extended side of an outer peripheral edge of the eye mask, the metallic strips are malleable deformable, and the extended side of the outer peripheral edge of the eye mask tightly fits on surface of the skin of the face of a user.

4. The mouth, nose and eye mask according to claim 1, wherein a surface of the thin sheet is plated with or a coating of an extremely thin film of a photo-catalyst is applied there onto, wherein composition of the film is primarily a chemical compound of titanic oxide (TiO₂).
